(19) United States
(12) Patent Application Publication
(10) Pub. No.: US 2012/0062790 A1
(43) Pub. Date: Mar. 15, 2012

(54) OPTICAL MEMBER AND OPTICAL MODULE

(75) Inventor: Minoru Tazoe, Tokyo (JP)

(73) Assignee: SONY CORPORATION, Tokyo (JP)

(21) Appl. No.: 13/223,369

(22) Filed: Sep. 1, 2011

(30) Foreign Application Priority Data
Sep. 9, 2010 (JP) 2010-202330

(51) Int. Cl. H04N 5/225; B32B 1/04

(52) U.S. Cl. 348/374; 428/68; 348/E05.024

(57) ABSTRACT

An optical member is disclosed which can prevent invasion of foreign articles into a space on a light path and can prevent deterioration of the yield in a manufacturing process. The optical member includes a first substrate, a second substrate opposed to the first substrate, a joining element for joining the first and second substrates together in a spaced relationship from each other so as to provide a space between the first substrate and the second substrate, and a porous member provided in the joining element. At least one of the first and second substrates is formed from an optical transmission member. The space between the substrates is closed by the joining element and the porous member.

### BACKGROUND

This disclosure relates to an optical member suitable for use with an imaging apparatus for picking up an image of an imaging object and so forth and also to an optical module which includes an optical device.

An optical module incorporated in a digital still camera, a portable telephone set or a like apparatus and including an imaging element called image sensor has been placed into practical use. In the optical module, the imaging element is mounted, for example, in an insulating substrate, and an optical member such as a lens barrel is provided on the imaging element. For an optical module having such a configuration just as described, a structure has been proposed that a space between the optical member and the insulating substrate is sealed with a partition wall or the like in order to prevent invasion of foreign articles and so forth into a space above the imaging element. Such a structure as just described is disclosed, for example, in Japanese Patent Laid-Open No. 2005-191660. In the case where the space above the imaging element is formed as a sealed space, for example, when the substrate is to be cut for singulation, even if dust is produced by cutting of the substrate or the like, invasion of foreign matters into the optical member provided in the space above the imaging element or on an optical path of light to be introduced to the imaging element can be prevented.

Meanwhile, as a manufacturing method for an optical module, a method is investigated wherein imaging elements are formed on the surface of a semiconductor substrate and an optical member is positioned with respect to and laminated on the substrate, whereafter the substrate is singulated into pixels for the individual elements. Also in such a manufacturing method as just described, the space between the semiconductor substrate and the optical member is formed as a sealed structure over the imaging elements. By this structure, invasion of foreign articles into the space above the elements, sticking of foreign articles to the optical members and so forth can be prevented upon dicing of the semiconductor substrate.

### SUMMARY

However, if the space above the imaging elements is placed in a sealed structure by the optical member or a partition wall, then the optical member or the partition wall is sometimes damaged by expansion of gas in the sealed space or the like upon reflowing. Upon such damage, positional displacement between the imaging elements and the optical members or the like occurs, resulting in deterioration of the yield in manufacture of optical modules.

Accordingly, it is demanded to achieve a structure for an optical member and an optical module which can prevent invasion of foreign articles into a space above imaging elements or into the optical member provided on a path of light incoming to the imaging devices and can prevent damage by heat upon reflowing or the like.

Therefore, the present disclosure provides an optical member and an optical module which can prevent invasion of foreign articles into a space on a light path and can prevent deterioration of the yield in a manufacturing process.

According an embodiment of the present disclosure, there is provided an optical member including a first substrate, a second substrate opposed to the first substrate, a joining element adapted to join the first and second substrates together in a spaced relationship from each other so as to provide a space between the first substrate and the second substrate, and a porous member provided in the joining element, at least one of the first and second substrates being formed from an optical transmission member, the space being closed by the joining element and the porous member.

According to another embodiment of the present disclosure, there is provided an optical module including an imaging element, an optical member having an optical transmission member provided on an optical path of light incoming to the imaging element, a joining element adapted to join the imaging element and the optical member together in a spaced relationship from each other so as to provide a space between the imaging element and the optical member, and a porous member provided in the joining element, the space being closed by the joining element and the porous member.

In the optical member and the optical module, the space between the substrates or between the optical member and the imaging element is closed up by the joining element and the porous member. Therefore, invasion of foreign matters into the space can be prevented. Further, since the porous member is used to form the closed space, the air, water vapor or the like can flow between the space and the outside of the optical member through the porous member. Consequently, otherwise possible damage upon rise of the internal pressure by an influence of the gas in the closed space can be prevented. As a result, deterioration of the yield in the manufacturing process can be prevented.

In summary, with the optical member and the optical module, invasion of foreign matters to an optical path and deterioration of the yield in the manufacturing process can be prevented.

The above and other features and advantages of the technique disclosed herein will become apparent from the following description and the appended claims, taken in conjunction with the accompanying drawings in which like parts or elements denoted by like reference characters.

### BRIEF DESCRIPTION OF THE DRAWINGS

FIGS. 1A to 1E, 2A to 2G and 3A to 3F are schematic views illustrating different steps of a manufacturing method of an optical member;

FIGS. 4A and 4B are a sectional view and a fragmentary perspective view, respectively, schematically showing a configuration of an optical member according to a first embodiment of the disclosed technology;

FIGS. 5A to 5C are schematic sectional views illustrating successive steps of a manufacturing method for an optical member according to the first embodiment of the disclosed technology;

FIGS. 6A and 6B are a sectional view and a fragmentary perspective view, respectively, schematically showing a configuration of an optical member according to a second embodiment of the disclosed technology;

FIGS. 7A to 7D are schematic sectional views illustrating successive steps of a manufacturing method for an optical member according to the second embodiment of the disclosed technology;

FIGS. 8A and 8B are a sectional view and a fragmentary perspective view, respectively, schematically showing a configuration of an optical member according to a third embodiment of the disclosed technology;

FIGS. 9A to 9D are schematic sectional views illustrating successive steps of a manufacturing method for an optical member according to the third embodiment of the disclosed technology;

FIGS. 10A and 10B are a sectional view and a fragmentary perspective view, respectively, schematically showing a configuration of an optical member according to a fourth embodiment of the disclosed technology;

FIGS. 11A to 11D are schematic sectional views illustrating successive steps of a manufacturing method for an optical member according to the fourth embodiment of the disclosed technology; and

FIG. 12 is a schematic sectional view showing a configuration of an optical module according to an embodiment of the disclosed technology.

### DETAILED DESCRIPTION OF THE PREFERRED EMBODIMENTS

In the following, preferred embodiments of the disclosed technology are described. However, the disclosed technology is not limited to the embodiments described below.

It is to be noted that the description is given in the following order.
1. Manufacturing Method of an Optical Member
2. First Embodiment of the Optical Member
3. Manufacturing Method of the Optical Member of the First Embodiment
4. Second Embodiment of the Optical Member
5. Manufacturing Method of the Optical Member of the Second Embodiment
6. Third Embodiment of the Optical Member
7. Manufacturing Method of the Optical Member of the Third Embodiment
8. Fourth Embodiment of the Optical Member
9. Manufacturing Method of the Optical Member of the Fourth Embodiment
10. Embodiment of the Optical Module

### 1. Manufacturing Method of an Optical Member

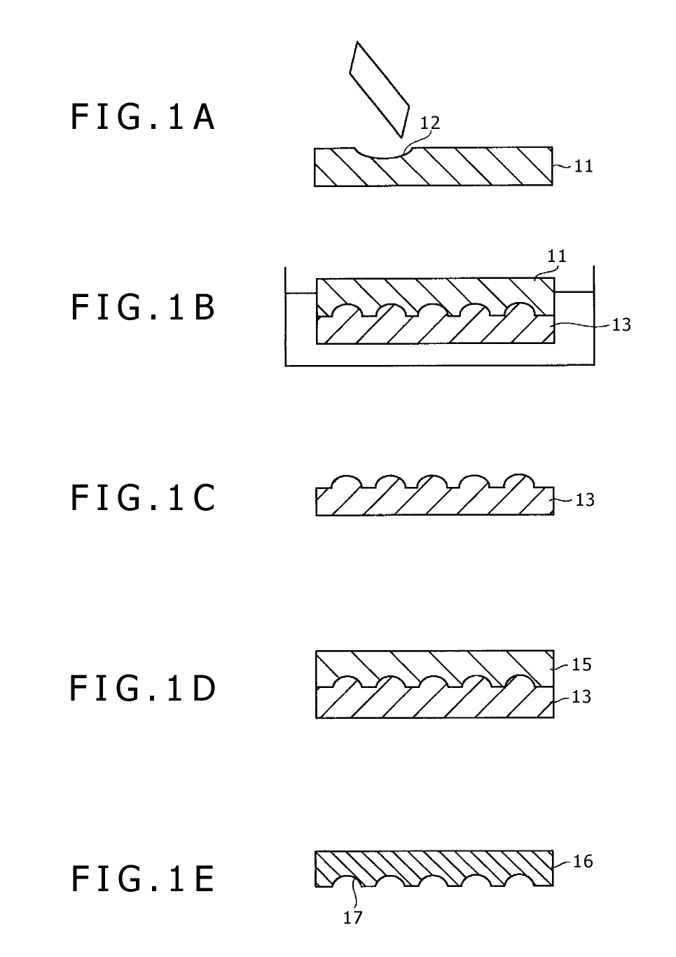

In the following, particular embodiments of the optical member of the disclosed technology are described. FIGS. 1A to 1E illustrate a basic manufacturing process for an optical member.

In the manufacturing method for an optical member according to the embodiment, an optical transmission member is used for both of first and second substrates. The optical transmission member used here is configured such that lens portions are formed on both faces of the optical transmission member through which light is transmitted.

First, a stamper or mold for producing a substrate of an optical member is produced.

In particular, a metal mold 11 is subjected to machining, etching or the like as seen in FIG. 1A. By this working, a concave portion 12 corresponding to an optical face to be provided on a lens to be produced is formed on the metal mold 11. A plurality of such concave portions 12 are disposed in parallel on the surface of the metal mold 11.

Then, electroforming, for example, by electroless plating is carried out using the metal mold 11 on which the concave portions 12 are formed as seen in FIG. 1B. By the electroless plating, an electroforming replica or stamper 13 made of nickel or the like and having convex portions 14 transferred thereto which have patterns reverse to those of the concave portions 12 of the metal mold 11 as seen in FIG. 1C can be formed.

Then, the electroforming replica 13 is pressed at the face thereof on which the convex portions 14 are formed against thermosetting resin 15 as seen in FIG. 1D. Then, the thermosetting resin 15 and the electroforming replica 13 are heated in a state in which they are fixed to each other. By this step, a resin replica 16 to which the patterns of the convex portions 14 of the electroforming replica 13 are transferred can be formed. On the resin replica 16, patterns of a plurality of concave portions 17 corresponding to the optical face of lenses to be produced are formed in parallel similarly to the concave portions 12 of the metal mold 11 shown in FIG. 1A.

Then, a lens substrate which makes a substrate for an optical member is produced using the resin replica 16.

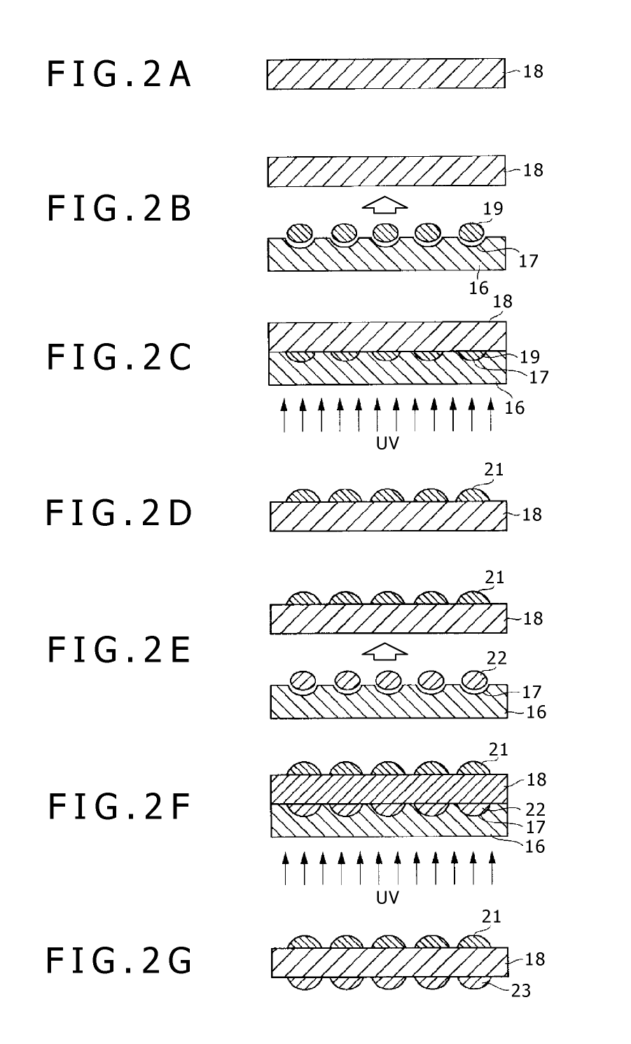

In particular, a glass substrate 18 is produced as shown in FIG. 2A. Then, the resin replica 16 having ultraviolet curing resin 19 spread to the concave portions 17 thereof produced in such a manner as described above is pressed against one of the faces of the glass substrate 18 as seen in FIG. 2B.

Then, ultraviolet rays (UV) are irradiated on the ultraviolet curing resin 19 from the resin replica 16 side in a state in which the resin replica 16 contacts with the glass substrate 18 as seen in FIG. 2C. Consequently, the ultraviolet curing resin 19 is hardened in a state in which the optical faces of the resin replica 16 are transferred thereto thereby to form lens portions 21. A thermal hardening process is carried out further for the lens portions 21 to harden and stabilize the lens portions 21.

By the steps described above, a lens substrate having the lens portions 21 formed on one face of the glass substrate 18 as seen in FIG. 2D can be produced.

Then, the resin replica 16 having ultraviolet curing resin 22 spread to the concave portions 17 thereof is contacted with the face of the glass substrate 18 on which the lens portions 21 are not formed as seen in FIG. 2E.

Then, in the state in which the resin replica 16 contacts with the glass substrate 18, ultraviolet rays (UV) are irradiated upon the ultraviolet curing resin 22 from the resin replica 16 side as seen in FIG. 2F. Consequently, the ultraviolet curing resin 22 is hardened in a state in which the optical faces of the resin replica 16 are transferred thereto thereby to form lens portions 23. Further, a thermal hardening process is carried out for the lens portions 23 to harden and stabilize the lens portions 23.

By the processes described above, a lens substrate 20 having the lens portions 21 and 23 formed on the opposite faces of the glass substrate 18 thereof as seen in FIG. 2G can be produced.

Thereafter, an optical member is produced using the lens substrate 20. In the method described below, a method of producing an optical member formed from two lens substrates is described.

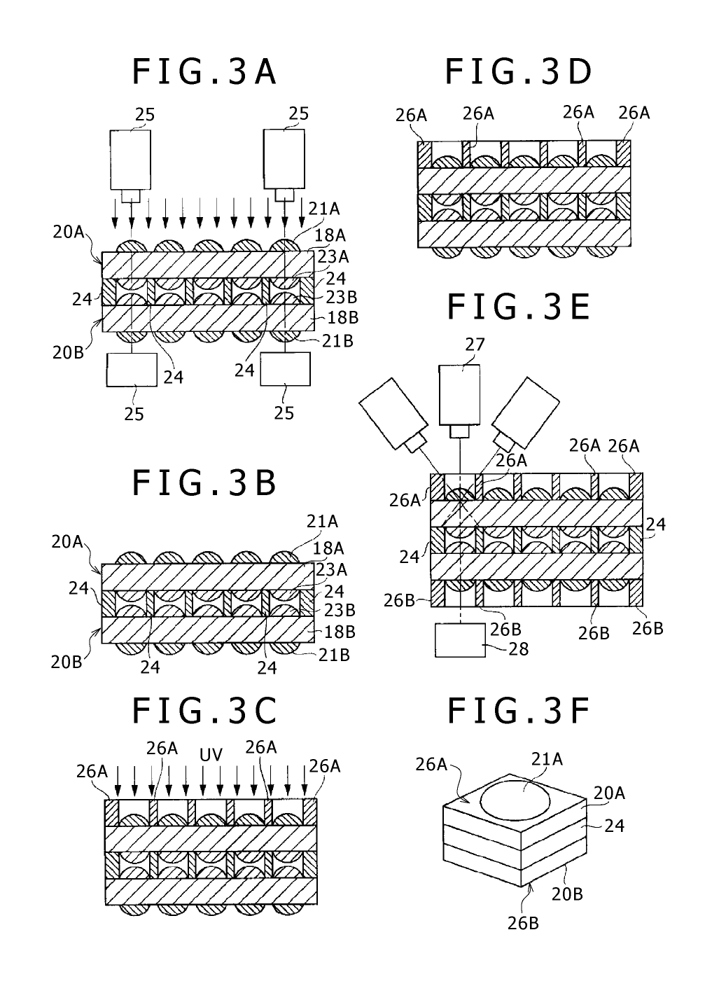

A first lens substrate 20A and a second lens substrate 20B are laminated to each other by joining elements 24 as seen in FIG. 3A. At this time, the first lens substrate 20A and the second lens substrate 20B are laminated to each other such that the lens portions 23A of the first lens substrate 20A and the lens portions 23B of the second lens substrate 20B are opposed to each other. A gap is provided between the first lens substrate 20A and the second lens substrate 20B such that the lens portions 23A and the lens portions 23B do not contact with each other.

The joining elements 24 are formed using, for example, ultraviolet curing resin. The joining elements 24 are formed at positions other than the positions of the lens portions 23A and 23B of the first and second lens substrates 20A and 20B, that is, at positions except the optical faces of the first lens substrate 20A and the second lens substrate 20B. The joining elements 24 thus join the first lens substrate 20A and the second lens substrate 20B to each other surrounding the lens portions 23A and 23B which are the optical faces of the first lens substrate 20A and the second lens substrate 20B, respectively.

Upon joining of the first lens substrate 20A and the second lens substrate 20B, the lens portions 21A and 23A of the first lens substrate 20A and the lens portions 21B and 23B of the second lens substrate 20B are positioned accurately to each other. For example, alignment marks or the optical faces of the first lens substrate 20A and the second lens substrate 20B are utilized for the positioning using various sensors 25 such as image sensors or wavefront sensors.

After the first lens substrate 20A and the second lens substrate 20B are positioned relative to each other, ultraviolet rays are irradiated to harden the joining elements made of the ultraviolet curing resin.

By the joining structure described above, the first lens substrate 20A, second lens substrate 20B and joining elements 24 around the optical faces close up the space or gap among them as seen in FIG. 3B.

Then, a spacer 26A is formed on the face of the first lens substrate 20A on the lens portions 21A side as seen in FIG. 3C. The spacer 26A is formed at positions other than the positions of the lens portions 21A which form the optical faces of the first lens substrate 20A, for example, using an ultraviolet curing resin or the like. Then, ultraviolet rays are irradiated from the first lens substrate 20A side to harden the resin. Consequently, the spacer 26A is formed on the lens portions 21A side of the first lens substrate 20A as seen in FIG. 3D.

Similarly, a spacer 26B is formed on the lens portions 21B side of the second lens substrate 20B. The spacer 26B is formed by spreading ultraviolet curing resin or the like to the position of the second lens substrate 20B other than the positions of the lens portions 21B which are optical faces of the second lens substrate 20B and then irradiating ultraviolet rays.

Further, for example, a wavefront sensor 27 and a light source 28 are used to carry out inspection of a lens unit formed from the lens portions 21A and 23A of the first lens substrate 20A and the lens portions 21B and 23B of the second lens substrate 20B as seen in FIG. 3E.

Then, the first lens substrate 20A and the second lens substrate 20B are cut at the positions of the spacers 26A and 26B and the joining element 24 to carry out singulation. By the singulation, lens units are formed each including the lens portions 21A and 23A of the first lens substrate 20A and the lens portions 21B and 23B of the second lens substrate 20B. Then, after the singulation, each lens unit is subjected to cleaning and single part inspection to form an optical member 30 shown in FIG. 3F.

The optical member 30 described above includes a lens unit formed from the lens portions 21A and 23A of the first lens substrate 20A and the lens portions 21B and 23B of the second lens substrate 20B, and a joining element for joining the first lens substrate 20A and the second lens substrate 20B to each other. A gap provided between the first lens substrate 20A and the second lens substrate 20B is a space closed up or sealed with the two substrates and the joining element.

### 2. First Embodiment of the Optical Member

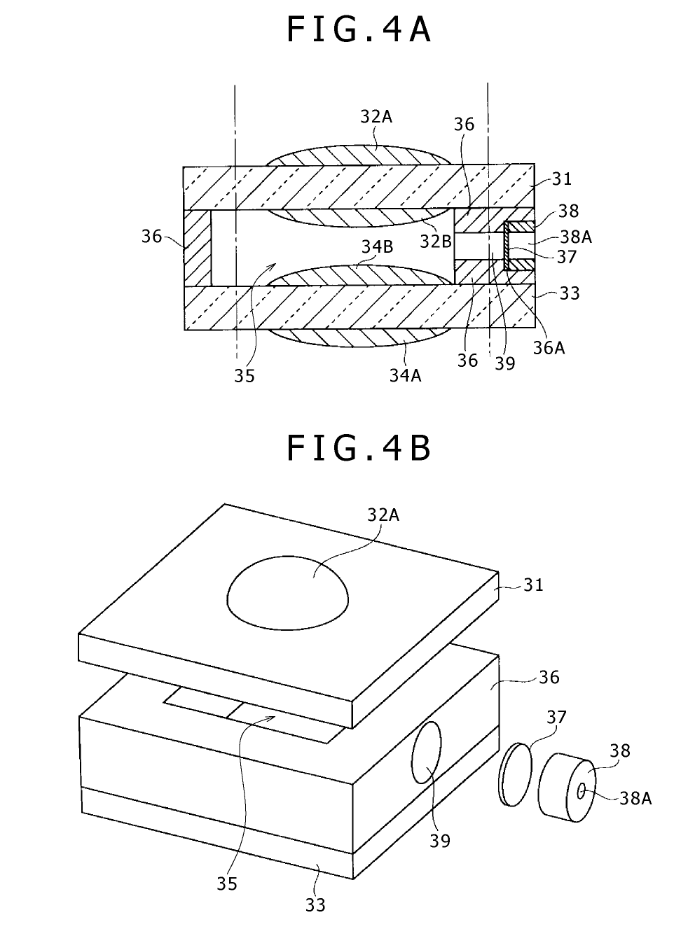

Now, an optical member according to a first embodiment is described. A sectional view of the optical member according to the first embodiment is shown in FIG. 4A, and a fragmentary perspective view of the optical member is shown in FIG. 4B.

The optical member is structured such that two substrates each formed from an optical transmission member are combined with each other and joined together at a periphery of the optical portion thereof.

Referring to FIGS. 4A and 4B, the optical member shown includes a first substrate 31, a second substrate 33, first optical portions 32A and 32B, second optical portions 34A and 34B, a joining element 36, a porous member 37 and a cap 38, and has an air hole 39 and a space 35.

The first and second substrates 31 and 33 are each configured from a substrate having an optical transmission property such as a glass substrate. The first optical portions 32A and 32B each formed from a convex lens portion are provided on the first substrate 31. The convex lens portions of the first optical portions 32A and 32B are provided substantially at the center of the first substrate 31. Meanwhile, the second optical portions 34A and 34B are each formed from a convex lens portion and are provided on the second substrate 33. The convex lens portions of the second optical portions 34A and 34B are provided substantially at the center of the second substrate 33.

The first and second substrates 31 and 33 are joined together by the joining element 36 with optical transmission faces thereof opposed to each other. The first and second optical portions 32A and 32B are provided on the outer face sides of the optical member while the first and second optical portions 32B and 34B are provided on the inner face sides of the optical member. In other words, the first and second substrates 31 and 33 are joined together such that the faces thereof on which the first and second optical portions 32B and 34B are formed are opposed to each other. Further, the first and second substrates 31 and 33 are joined together with a gap provided between the first and second optical portions 32B and 34B thereof. Therefore, in the optical member, the space 35 is provided which is enclosed at the upper face thereof by the first substrate 31, at the lower face thereof by the second substrate 33 and at the side face by the joining element 36.

The joining element 36 is formed at a peripheral portion of the first and second substrates 31 and 33 at which the first optical portions 32A and 32B and the second optical portions 34A and 34B are not formed. Further, the air hole 39 is provided at a portion of the joining element 36 in such a manner as to establish communication from the space 35 between the first and second substrates 31 and 33 to the outside.

The air hole 39 has a step 36A provided intermediately thereof such that the opening diameter on the inner side of the optical member, that is, on the space 35 side, is small while the opening diameter of the outer side is sufficiently greater than that of the inner side. The porous member 37 and the cap 38 are attached to the step 36A. The porous member 37 is preferably provided, for example, with a thickness of 0.10 to 0.45 mm.

The porous member 37 has a form of a sheet or a block and is made of a porous material having pores of 0.1 to 10 μm. Since the porous member 37 has the pores described above, it has water proofing and dust proofing properties and further has air permeability.

The porous member 37 is configured, for example, from fluorocarbon resin. As the fluorocarbon resin, for example, polytetrafluoro ethylene (TFE), partially fluoridated resin and copolymer of fluoridated resin can be used.

As the partially fluoridated resin, polychlorotrifluoroethylene (trifluoride resin PCTFE, CTFE), polyvinylidene fluoride (PVDF) and polyvinyl fluoride (PVF) can be used.

Meanwhile, as the copolymer of fluoridated resin, for example, perfluoroalkoxy resin (PFA), tetrafluoroethylene-propylene hexafluoride copolymer (FEP), ethylene-tetrafluoroethylene copolymer (ETFE) and ethylene-chlorotrifluoroethylene copolymer (ECTFE) can be used.

By using any of the fluorocarbon resins, the porous member 37 having properties such as water repellency, heat resistance, chemical resistance, weather resistance and electric characteristics in addition to the water proofing and dust proofing properties and air permeability can be configured.

Meanwhile, for the porous member 37, a porous material having a Gurley number (s) of 4 to 35 s is used preferably. The Gurley number here depends upon the Gurley test prescribed in JIS P 8177. A measuring instrument for the Gurley number uses a paper and cardboard air permeability—Gurley test machine method (JIS P 8117: 1998). A result of the test is represented by “air permeability resistance (Gurley)” defined as time (seconds) in which the air of 100 mL permeates through paper of 642 mm².

Preferably, the porous member 37 is formed using a porous material having a Frajour value (cm³/c, m³/s) of 3 to 6 m²/s. The Frajour value mentioned here depends upon the Frajour test method as an air permeability test prescribed in JIS L 1096. According to this test method, the size of a specimen face air hole is set to a diameter of 70 mm and a suction fan is adjusted so that the pressure difference between the front and rear of the specimen may be 127 Pa. Then, the specimen permeating air amount (cc/s) in the conditions is determined.

Preferably, the porous member 37 is formed using a porous material having a water resistance (kPa) of 7 to 400 kPa. The water resistance here depends upon the B method (high water pressure method) prescribed in JIS L 1092. In this method, the “water resistance test method for textile goods” (water resistance, water repellency) “water resistance test method for textile goods” prescribes a water resistance test (low water pressure method, high water pressure method).

Although the porous member 37 is provided so as to close up the air hole 39, since it has the properties described above, flow of gas such as the air, water vapor and so forth between space 35 and the outside is permitted. Further, since the porous member 37 has a water proofing property and a dust proofing property, invasion of foreign matters into the space 35 of the optical member can be prevented.

The cap 38 is configured such that it contacts closely with the side wall of the air hole 39 of the joining element 36 and the porous member 37 such that no gap is formed between the porous member 37 and the joining element 36. Further, an air hole 38A similar to the air hole 39 of the joining element 36 is provided in the cap 38.

Accordingly, in the optical member shown in FIGS. 4A and 4B, the space 35 is formed by the first substrate 31, second substrate 33 and joining element 36. Then, the space 35 is closed by the first substrate 31, second substrate 33, joining element 36 and porous member 37.

Further, the optical member is structured such that, since the porous member 37 has the properties described hereinabove, the space 35 and the outside are communicated with each other through the air hole 39 of the joining element 36, the pores of the porous member 37 and the air hole 38A of the cap 38. According to this structure, gas such as the air and water vapor can be communicated between the space 35 of the optical member and the outside through the porous member 37. Further, invasion of foreign matters such as water and dust into the space 35 of the optical member can be prevented by the water proofing and dust proofing properties of the porous member 37.

### 3. Manufacturing Method of the Optical Member of the First Embodiment

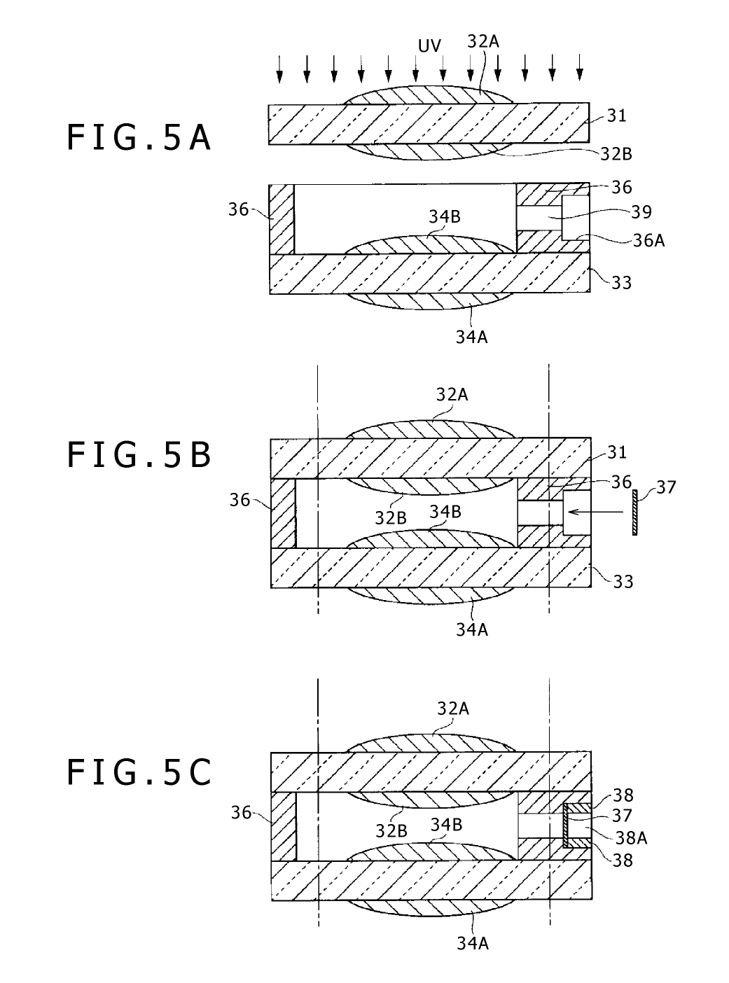

Now, a manufacturing method of the optical member of the first embodiment described above is described. A manufacturing process of the optical member of the first embodiment is illustrated in FIGS. 5A to 5C. It is to be noted that, in the following description, only differences of the manufacturing process from the basic manufacturing process of the optical member described hereinabove with FIGS. 1A to 3F when the optical member of the first embodiment is manufactured are described.

First, a joining element 36 is formed from a bonding agent made of an ultraviolet curing resin or the like on a second substrate 33 as seen in FIG. 5A. In particular, the ultraviolet curing resin is applied in a series of patterns surrounding the outer periphery of the second substrate 33 except the portions at which the second optical portions 34A and 34B are provided to form the joining element 36. Further, an air hole 39 having an opening diameter which changes intermediately thereof in the thicknesswise direction is formed in the joining element 36. The air hole 39 has the step 36A provided thereon such that the opening diameter on the inner side, that is, on the space 35 side, of the optical member is small while that on the outer side is sufficiently greater than that on the inner side.

Then, a first substrate 31 is placed on the joining element 36. Then, ultraviolet rays are irradiated upon the joining element 36 to harden the joining element 36 thereby to adhere the first substrate 31 and the second substrate 33 to each other. After the joining element 36 is hardened, the first substrate 31 and the second substrate 33 are cut at the joining element 36 to carry out singulation.

After the optical member is singulated, a porous member 37 is attached to the step 36A of the joining element 36 as seen in FIG. 5B. The porous member 37 is provided so as to close up the air hole 39 of the joining element 36.

After the porous member 37 is attached to the joining element 36, a cap 38 is attached to the air hole 39 of the joining element 36 to suppress the porous member 37 as seen in FIG. 5C. The joining element 36 and the cap 38 are adhered and secured at contact faces thereof to each other using a bonding agent or the like.

The optical member of the first embodiment can be manufactured by the steps described above.

### 4. Second Embodiment of the Optical Member

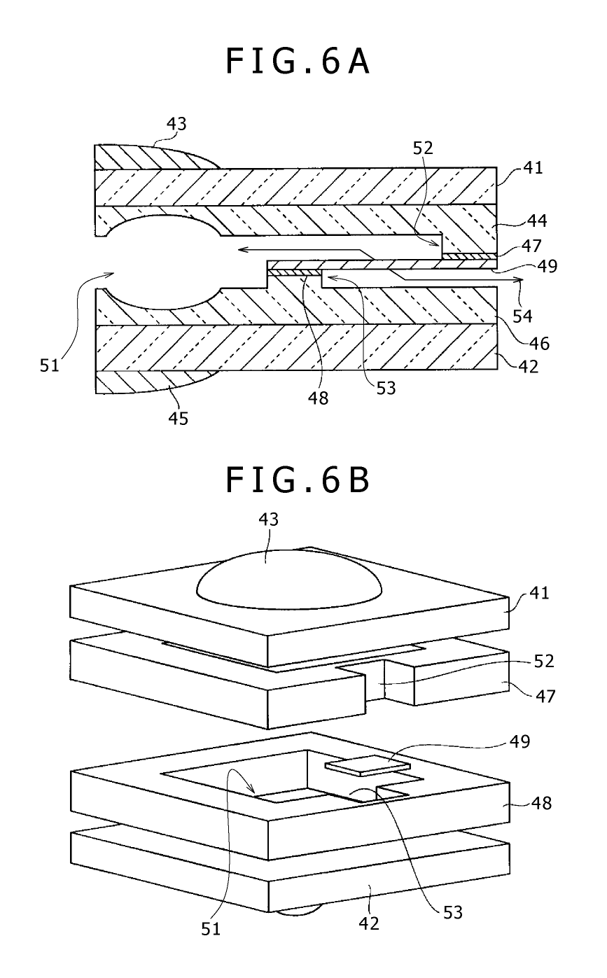

A second embodiment of the optical member is described below. A sectional view of the optical member according to the second embodiment is shown in FIG. 6A, and a fragmentary perspective view of the optical member is shown in FIG. 6B.

This optical member is structured such that a substrate formed from an optical transmission member having a convex lens portion formed as an optical portion on the outer face side thereof and a concave lens portion formed as an optical portion on the inner face side thereof is used for joining around an optical portion.

The optical member shown in FIGS. 6A and 6B includes a first substrate 41, a second substrate 42, a first joining element 47 and a second joining element 48 and has a space 51 surrounded by the members mentioned. The first substrate 41 and the second substrate 42 are each formed from an optical transmission member.

The first substrate 41 and the second substrate 42 are each formed from a substrate having an optical transmission property such as a glass substrate. The first substrate 41 has a first optical portion 43 formed from a convex lens portion provided on the outer face side of the optical member and has a second optical portion 44 having a concave lens portion provided on the inner face side, that is, on the space 51 side. The convex lens portion of the first optical portion 43 is provided substantially at the center of the first substrate 41. The second optical portion 44 covers the overall inner face side of the first substrate 41 and has a concave lens portion provided at a position symmetrical to the first optical portion 43 with respect to the first substrate 41.

The second substrate 42 includes a third optical portion 45 formed from a convex lens portion provided on the outer face side of the optical member and a fourth optical portion 46 having a concave lens portion provided on the inner face side, that is, on the space 51 side. The convex lens portion of the third optical portion 45 is provided substantially at the center of the second substrate 42. The fourth optical portion 46 covers the overall inner face side of the second substrate 42 and has a concave lens portion provided at a position symmetrical to the third optical portion 45 with respect to the second substrate 42.

The first substrate 41 and the second substrate 42 are joined together by the first joining element 47 and the second joining element 48 with the optical transmission faces thereof opposed to each other. The first joining element 47 is provided at an outer peripheral portion of the second optical portion 44 provided on the inner face side of the first substrate 41 at which the optical face is not provided. Meanwhile, the second joining element 48 is provided at an outer peripheral portion of the fourth optical portion 46 provided on the inner face side of the second substrate 42 at which the optical face is not formed. The first joining element 47 and the second joining element 48 are abutted with each other such that the first substrate 41 and the second substrate 42 are joined together such that the faces thereof on which the second optical portion 44 and the fourth optical portion 46 are formed are opposed to each other. Further, the first substrate 41 and the second substrate 42 are joined together such that a gap is provided between the second optical portion 44 and the fourth optical portion 46. Therefore, in the optical member, the space 51 surrounded at the upper face thereof by the first substrate 41, at the lower face thereof by the second substrate 42 and at the side face thereof by the first joining element 47 and the second joining element 48 is provided.

Further, as seen in FIG. 6B, concave portions 52 and 53 are provided at positions of the first joining element 47 and the second joining element 48 at which the concave portions 52 and 53 overlap with each other. A concave portion 52 is formed on the outer face side of the first joining element 47 while a concave portion 53 is formed on the inner face side of the second joining element 48. Therefore, by joining the first joining element 47 and the second joining element 48 to each other with the concave portion 52 and the concave portion 53 placed one on the other as seen in FIG. 6A, an air hole 54 which communicates from the space 51 with the outside is formed from the concave portion 52 and the concave portion 53.

Further, as seen in FIG. 6A, a porous member 49 is provided between the first joining element 47 and the second joining element 48 in the air hole 54. The porous member 49 is formed as a film of an area greater than the concave portion 52 and the concave portion 53 as seen in FIG. 6B. The porous member 49 covers the concave portion 52 and is connected to the first joining element 47 and further covers the concave portion 53 and is connected to the second joining element 48. Therefore, the air hole 54 is closed up with the porous member 49.

Accordingly, in the optical member shown in FIGS. 6A and 6B, the air hole 54 is formed by the first substrate 41 (second optical portion 44), second substrate 42 (fourth optical portion 46), first joining element 47 and second joining element 48. Further, the air hole 54 is closed up with the second substrate 42 (fourth optical portion 46), first joining element 47, second joining element 48 and porous member 49.

The porous member 49 may be formed using a material having properties similar to those of the optical member of the first embodiment described hereinabove.

Therefore, the optical member is structured such that the space 51 and the outside are communicated with each other through the air hole 54 and the porous member 49. With the structure just described, gas such as the air or water vapor can flow between the space 51 of the optical member and the outside through the porous member 49, and besides invasion of foreign matters such as water or dust into the space 51 of the optical member can be prevented.

### 5. Manufacturing Method of the Optical Member of the Second Embodiment

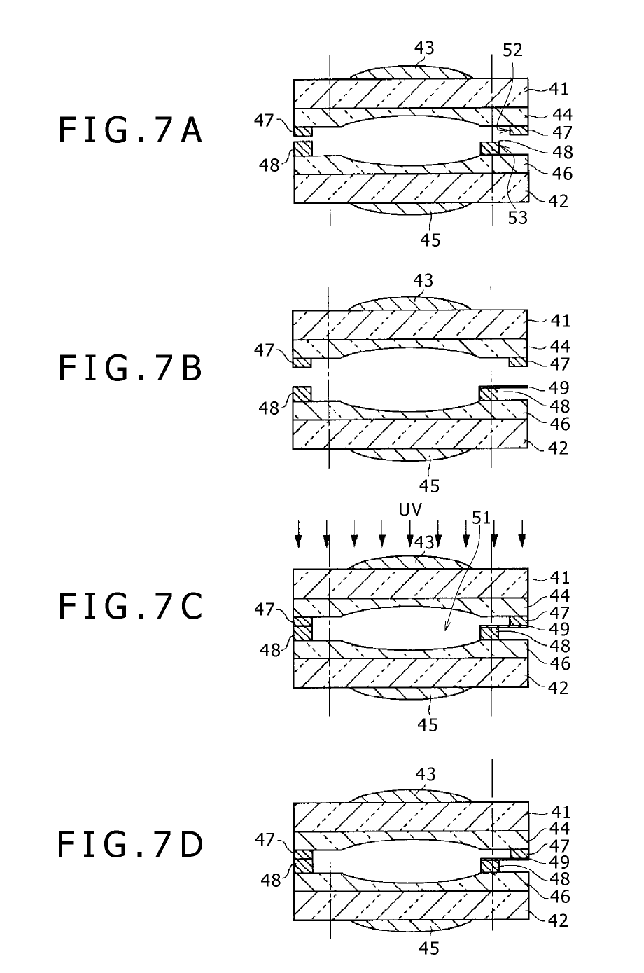

Now, a manufacturing method of the optical member of the second embodiment described above is described. A manufacturing process of the optical member of the second embodiment is illustrated in FIGS. 7A to 7D. It is to be noted that, in the following description, only differences of the manufacturing process from the basic manufacturing process of the optical member described hereinabove with FIGS. 1A to 3F when the optical member of the second embodiment is manufactured are described.

First, a first joining element 47 is formed from a bonding agent made of an ultraviolet curing resin or the like on a first substrate 41 on which a first optical portion 43 and a second optical portion 44 are formed. Further, a second joining element 48 is formed from a bonding agent made of an ultrasonic curing resin or the like on a second substrate 42 on which a third optical portion 45 and a fourth optical portion 46 are formed. To the first joining element 47 and the second joining element 48, ultraviolet curing resin is applied in a series of patterns surrounding the outer side on the inner face side except those portions at which the optical portions of the first substrate 41 and the second substrate 42 are provided.

At this time, a concave portion 52 is formed on the first joining element 47 while a concave portion 53 is formed on the second joining element 48. The concave portion 52 and the concave portion 53 are provided at places of the first joining element 47 and the second joining element 48 at which they overlap with each other when the first joining element 47 and the second joining element 48 are joined together. Then, one of the concave portions is shaped so as to be open toward the outer side of the optical member while the other concave portion is shaped so as to be open toward the inner side of the optical member, that is, toward the space 51 side.

Then, a porous member 49 is attached between the concave portion 52 and the concave portion 53 as seen in FIG. 7B. In FIG. 7B, the porous member 49 is attached so as to close up the concave portion 53 of the second joining element 48.

Then, the first substrate 41 and the second substrate 42 are positioned relative to each other and the first joining element 47 and the second joining element 48 are joined together as seen in FIG. 7C. Since the first joining element 47 and the second joining element 48 are joined together, the air hole 54 is formed from the concave portion 52 open toward the inner side, a portion at which the concave portion 52 and the concave portion 53 overlap with each other, and the concave portion 53 open toward the outer side. Then, this air hole 54 is sealed with a porous member 49 attached between the concave portion 52 and the concave portion 53.

Further, ultraviolet rays are irradiated upon the first joining element 47 and the second joining element 48 to harden the same thereby to join the first substrate 41 and the second substrate 42 to each other.

Then, after the joining elements are hardened, the first substrate 41 and the second substrate 42 are cut at the first joining element 47 and the second joining element 48 except the porous member 49 to carry out singulation as seen in FIG. 7D. After the singulation, a heat treatment or the like is carried out for the optical member to thermally harden the joining elements.

The optical member of the second embodiment can be manufactured by the steps described above.

### 6. Third Embodiment of the Optical Member

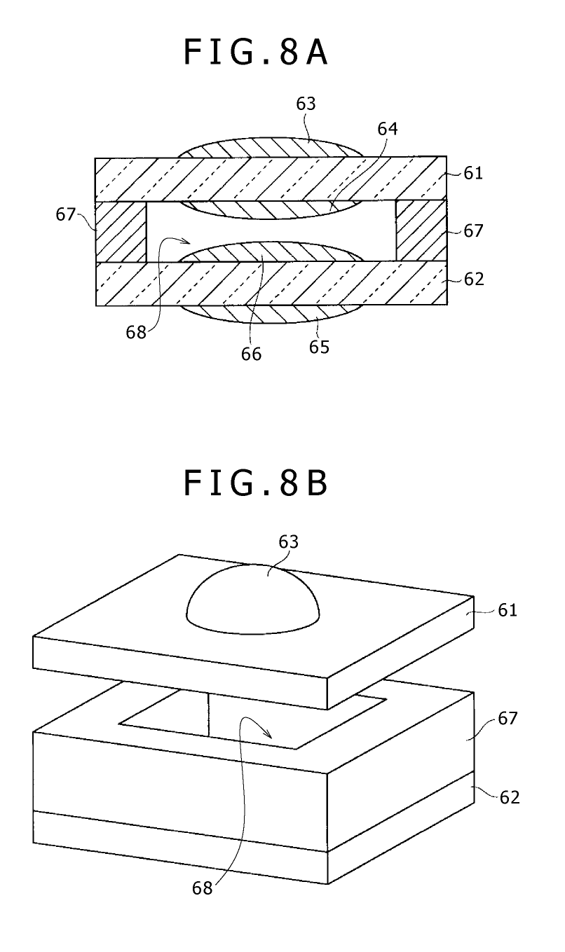

A third embodiment of the optical member is described below. A sectional view of the optical member according to the third embodiment is shown in FIG. 8A, and a fragmentary perspective view of the optical member is shown in FIG. 8B.

This optical member is structured such that a substrate formed from an optical transmission member having convex lens portions as optical portions formed on the outer face side and the inner face side thereof is used for joining around the optical portions.

Referring to FIGS. 8A and 8B, the optical member shown includes a first substrate 61, a second substrate 62 and a porous member 67, and has a space 68 surrounded by the components mentioned. The first substrate 61 and the second substrate 62 are each formed from an optical transmission member.

The first substrate 61 and the second substrate 62 are each formed from a substrate having an optical transmission property such as a glass substrate. The first substrate 61 has a first optical portion 63 formed from a convex lens portion on the outer face side of the optical member and has a second optical portion 64 provided on the inner face side, that is, the space 68 side, and having a convex lens portion. The convex lens portion of the first optical portion 63 is provided substantially at the center of the first substrate 61. The second optical portion 64 is provided at a position of a central portion on the inner face side of the first substrate 61 symmetrical to the first optical portion 63 with respect to the first substrate 61.

Meanwhile, the second substrate 62 includes a third optical portion 65 provided on the outer face side of the optical member and formed from a convex lens portion and includes a fourth optical portion 66 provided on the inner face side, that is, on the space 68 side, of the optical member and having a convex lens portion. The convex lens portion of the third optical portion 65 is provided substantially at the center of the second substrate 62. The fourth optical portion 66 is provided at a position of a central portion on the inner face side of the second substrate 62 symmetrical to the third optical portion 65 with respect to the second substrate 62.

The first substrate 61 and the second substrate 62 are joined together by the porous member 67 with the optical transmission faces thereof opposed to each other.

The porous member 67 is provided at an outer peripheral portion on the inner face sides of the first substrate 61 and the second substrate 62 at which the optical faces of the second optical portion 64 and the third optical portion 65 are not formed. In particular, partition walls which support the first substrate 61 and the second substrate 62 of the optical member are all configured from a porous member.

Further, the porous member 67 is joined to the first substrate 61 and the second substrate 62 by a bonding agent or the like not shown.

Further, as shown in FIG. 8B, the porous member 67 is formed from a series of patterns which surround an outer periphery of the first substrate 61 and the second substrate 62.

Therefore, a gap is provided between the first substrate 61 and the second substrate 62 with the porous member 67 interposed therebetween.

In this manner, the optical member shown in FIGS. 8A and 8B has the space 68 surrounded at the upper face thereof by the first substrate 61, at the lower face thereof by the second substrate 62 and at the side face thereof by the porous member 67. The space 68 has a closed structure.

The porous member 67 can be formed using a material having properties similar to those of the optical member of the first embodiment described hereinabove. Further, in the optical member of the present embodiment, it is necessary for the porous member 67 to have strength as a partition wall for supporting the first substrate 61 and the second substrate 62. Therefore, the porous member 67 is configured so as to be sufficiently thick.

In this manner, the optical member is structured such that the space 68 therein and the outside are communicated with each other through the porous member 67. With this structure, gas such as the air, water vapor or the like can flow between the space 68 of the optical member and the outside through the porous member 67, and besides, invasion of foreign matters such as water, dust and so forth into the space 68 of the optical member can be prevented.

### 7. Manufacturing Method of the Optical Member of the Third Embodiment

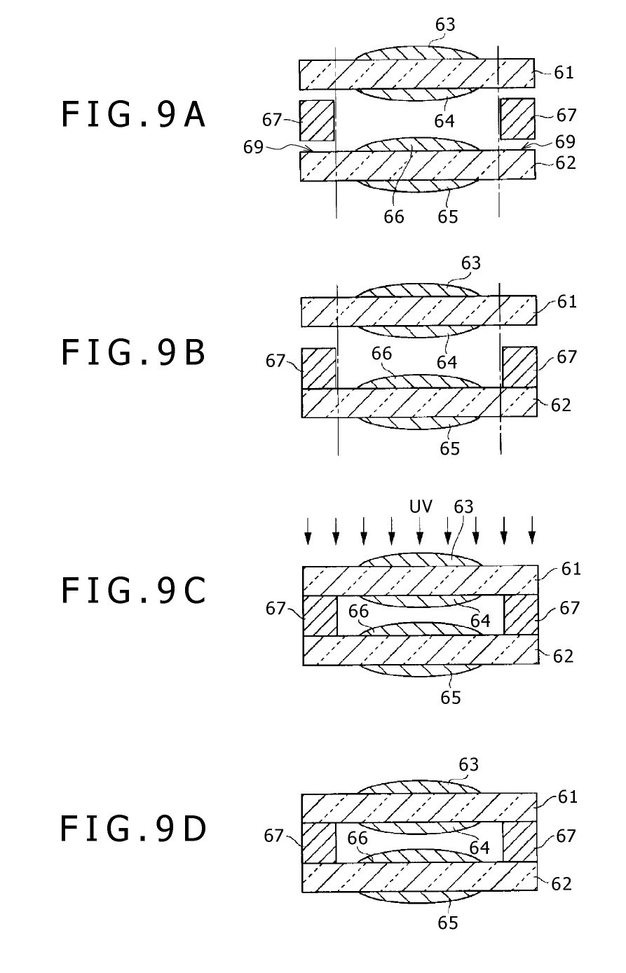

Now, a manufacturing method of the optical member of the third embodiment described above is described. A manufacturing process of the optical member of the third embodiment is illustrated in FIGS. 9A to 9D. It is to be noted that, in the following description, only differences of the manufacturing process from the basic manufacturing process of the optical member described hereinabove with FIGS. 1A to 3F when the optical member of the third embodiment is manufactured are described.

First, a bonding agent made of ultraviolet curing resin or the like is spread to a joining element 69 of a second substrate 62 on which a third optical portion 65 and a fourth optical portion 66 are formed. Then, a porous member 67 is attached to the joining element 69. The porous member 67 is provided in a series of patterns as a partition wall for supporting the first substrate 61 and the second substrate 62 of the optical member around a peripheral portion of the first substrate 61 and the second substrate 62.

Subsequently, a bonding agent made of ultraviolet curing resin or the like is spread to the upper face of the porous member 67 bonded to the second substrate 62 as seen in FIG. 9B. Then, the first substrate 61 and the porous member 67 are bonded to each other with the first substrate 61 and the second substrate 62 thereof positioned relative to each other as seen in FIG. 9C. Then, ultraviolet rays are irradiated upon the bonded portion to harden the bonding agent made of ultraviolet curing resin. Consequently, the first substrate 61 and the second substrate 62 are joined together by the porous member 67.

Then, after the bonding portion is hardened, the first substrate 61 and the second substrate 62 are cut at the porous member 67 as seen in FIG. 9D to carry out singulation. After the singulation, a heat treatment or the like is carried out for the optical member to thermally harden the joining element.

The optical member of the second embodiment can be manufactured by the process described above.

### 8. Fourth Embodiment of the Optical Member

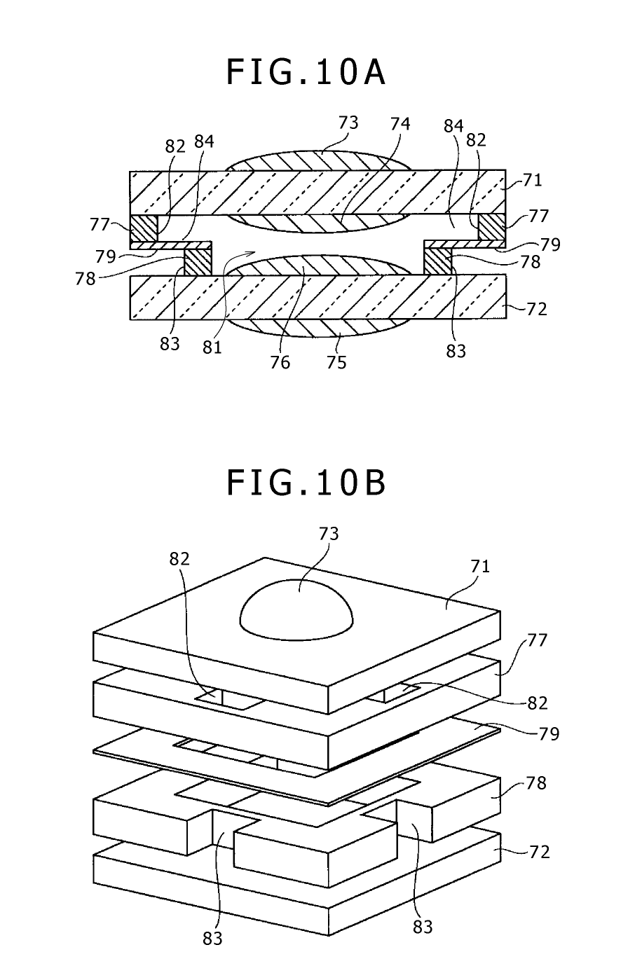

A fourth embodiment of the optical member is described below. A sectional view of the optical member according to the fourth embodiment is shown in FIG. 10A, and a fragmentary perspective view of the optical member is shown in FIG. 10B.

This optical member is structured such that a substrate formed from an optical transmission member having convex lens portions as optical portions formed on the outer face side and the inner face side thereof is used for joining around the optical portions.

The optical member shown in FIGS. 10A and 10B includes a first substrate 71, a second substrate 72, a first joining element 77 and a second joining element 78, and has a space 81 surrounded by the components. The first substrate 71 and the second substrate 72 are each formed from an optical transmission member.

The first substrate 71 and the second substrate 72 are each formed from a substrate having an optical transmission property such as a glass substrate. The first substrate 71 includes a first optical portion 73 provided on the outer face side of the optical member and formed from a convex lens portion and includes a second optical portion 74 provided on the inner face side, that is, on the space 81 side, of the optical member and having a convex lens portion. The convex lens portion of the first optical portion 73 is provided substantially at the center of the first substrate 71. The second optical portion 74 is provided at a position of a central portion of the inner face side of the first substrate 71 symmetrical to the first optical portion 73 with respect to the first substrate 71.

Meanwhile, the second substrate 72 includes a third optical portion 75 provided on the outer face side of the optical member and formed from a convex lens and includes a fourth optical portion 76 provided on the inner face side of the optical member, that is, on the space 81 side and having a convex lens. The convex lens portion of the third optical portion 75 is provided substantially at the center of the second substrate 72. The fourth optical portion 76 is provided at a position of a central portion of the inner face side of the second substrate 72 symmetrical to the third optical portion 75 with respect to the second substrate 72.

The first substrate 71 and the second substrate 72 are joined together by the first joining element 77 and the second joining element 78 with the optical transmission faces thereof opposed to each other. The first joining element 77 is provided at an outer peripheral portion of the inner face side of the first substrate 71 at which the optical face of the second optical portion 74 is not formed. Meanwhile, the second joining element 78 is provided at an outer peripheral portion of the inner face side of the second substrate 72 at which the optical face of the fourth optical portion 76 is not formed. The first joining element 77 and the second joining element 78 contact with each other and the first substrate 71 and the second substrate 72 are joined together such that the faces thereof on which the second optical portion 74 and the fourth optical portion 76 are formed are opposed to each other. Further, the first substrate 71 and the second substrate 72 are joined together such that a gap is provided between the second optical portion 74 and the fourth optical portion 76. To this end, in the optical member, the space 81 surrounded at the upper face thereof by the first substrate 71, at the lower face thereof by the second substrate 72 and at the side face thereof by the first joining element 77 and the second joining element 78 is provided.

Further, concave portions 82 and 83 are provided at positions of the first joining element 77 and the second joining element 78 at which they overlap with each other when they are joined together as seen in FIG. 10B. The concave portions 82 and 83 are provided by one set for each of the four sides of the side wall of the optical member. Further, the concave portions 82 are formed on the outer face side of the first joining element 77 while the concave portions 83 are formed on the inner face side of the second joining element 78. Therefore, when the first joining element 77 and the second joining element 78 are joined together with the concave portions 82 and the concave portions 83 placed one on the other as seen in FIG. 10A, air holes 84 which are communicated from the space 81 to the outside are formed from the concave portions 82 and the concave portions 83.

Further, a porous member 79 is provided between the first joining element 77 and the second joining element 78 in each of the air holes 84 as seen in FIG. 10A. The porous members 79 are formed as a film which covers the overall area of the faces along which the first joining element 77 and the second joining element 78 are joined together and cover the concave portions 82 and the concave portions 83 as seen in FIG. 10B. To this end, the first joining element 77 and the second joining element 78 are joined together through the porous member 79.

Further, since the first joining element 77 and the second joining element 78 are joined together covering the concave portions 82 and the concave portions 83, the air holes 84 are closed up by the porous member 79.

Accordingly, in the optical member shown in FIGS. 10A and 10B, the space 81 whose inside is sealed is defined by the first substrate 71, second substrate 72, first joining element 77, second joining element 78 and porous members 79.

The porous members 79 can be formed using a material having properties similar to those of the optical member of the first embodiment described hereinabove.

To this end, the optical member is structured such that the space 81 therein and the outside are communicated with each other through the air holes 84 and the porous members 79. With this structure, gas such as the air, water vapor or the like can flow between the space 81 of the optical member and the outside through the porous members 79, and besides, invasion of foreign matters such as water, dust and so forth into the space 81 of the optical member can be prevented.

### 9. Manufacturing Method of the Optical Member of the Fourth Embodiment

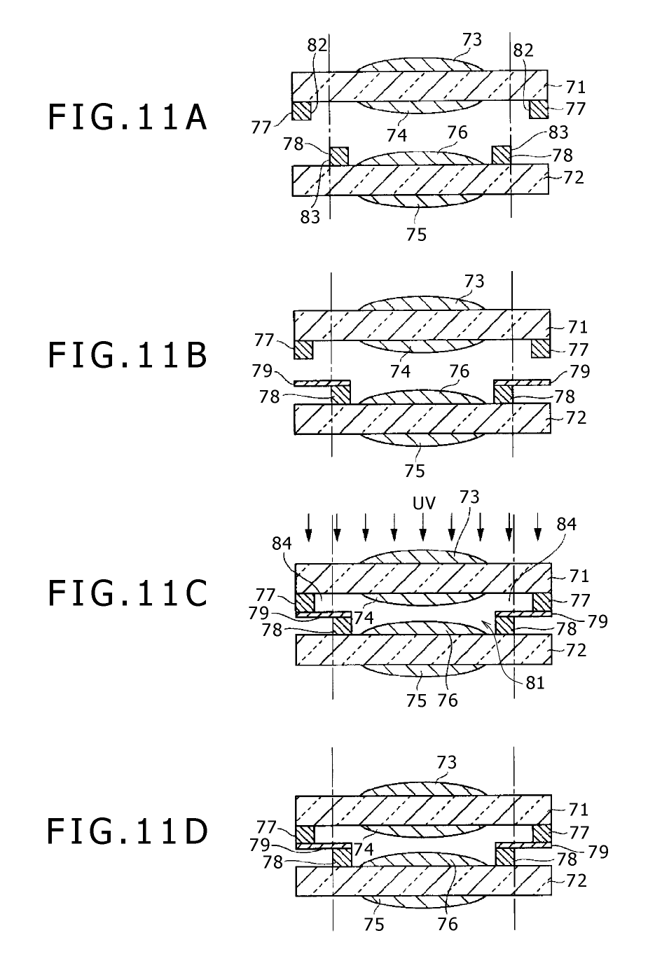

Now, a manufacturing method of the optical member according to the fourth embodiment described above is described. A manufacturing process of the optical member of the fourth embodiment is illustrated in FIGS. 11A to 11D. It is to be noted that, in the following description, only differences of the manufacturing process from the basic manufacturing process of the optical member described hereinabove with FIGS. 1A to 3F when the optical member of the fourth embodiment is manufactured are described.

First, a first joining element 77 is formed by a bonding agent made of ultraviolet curing resin or the like on a first substrate 71 on which a first optical section 73 and a second optical section 74 are formed as seen in FIG. 11A. Further, a second joining element 78 is formed by a bonding agent made of ultraviolet curing resin or the like on a second substrate 72 on which a third optical section 75 and a fourth optical section 76 are formed. The ultraviolet curing resin is spread in a series of patterns which surround an outer periphery of the first joining element 77 and the second joining element 78 on the inner face side except the portions at which the optical sections of the first substrate 71 and the second substrate 72 are provided.

At this time, concave portions 82 are formed on the first joining element 77 and concave portions 83 are formed on the second joining element 78. The concave portions 82 and 83 are provided at places at which the first joining element 77 and the second joining element 78 overlap with each other when they are joined together. Then, one of the concave portions 82 and 83 is formed in a shape open toward the outside of the optical member and the other one of the concave portions is formed in a shape open toward the inside of the optical member, that is, toward the space 81 side.

Then, porous members 79 are attached to the second joining element 78 as seen in FIG. 11B. In FIG. 11B, each of the porous members 79 is attached to the overall upper face of the second joining element 78 such that it closes the concave portion 83 of the second joining element 78.

Then, the first and second joining elements 77 and 78 are joined together with the first and second substrates 71 and 72 thereof positioned relative to each other as seen in FIG. 11C. By joining the first and second joining elements 77 and 78 to each other, air holes 84 are formed from the concave portions 82 open toward the inside, portions at which the concave portions 82 and 83 overlap with each other and concave portions 83 open toward the outside. Then, by the porous members 79 attached between the concave portions 82 and 83, the air holes 84 are sealed.

Further, ultraviolet rays are irradiated upon the first and second joining elements 77 and 78 to harden the bonding agent thereby to join the first and second substrate 71 and 72 to each other.

Then, after the joining elements are hardened, the first and second substrates 71 and 72 are cut at the first and second joining elements 77 and 78 thereof to carry out singulation. After the singulation, a heat treatment or the like is carried out for the optical member to thermally harden the joining elements.

By the processes described above, the optical member according to the fourth embodiment can be manufactured.

### 10. Embodiment of the Optical Module

Now, an embodiment of an optical module in which one of the optical members described above is used is described. In the following description, while an imaging apparatus in which an imaging element is formed on a substrate is described as the optical module, the optical module is not limited to this.

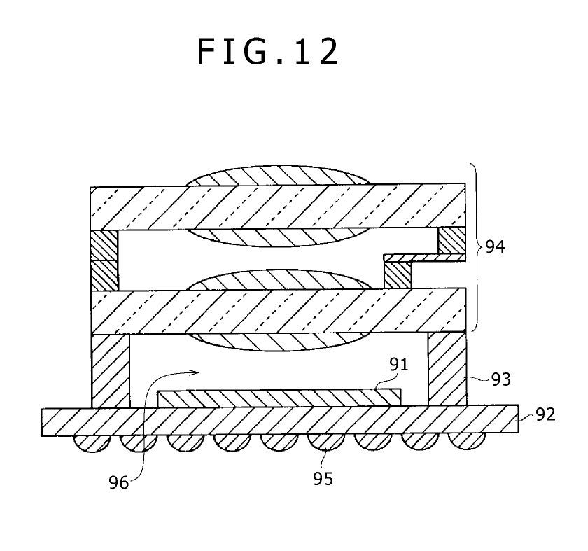

A sectional view of the optical module according to the present embodiment is shown in FIG. 12. Referring to FIG. 12, the optical module shown includes an imaging element 91, a mounting substrate 92 on which the imaging element 91 is mounted, and an optical member 94 provided above the imaging element 91. The imaging element 91 may be formed using, for example, a CCD (charge-coupled device) image sensor or a CMOS (complementary metal-oxide semiconductor) image sensor. Further, the optical module includes the optical member according to the second embodiment described above. It is to be noted that not only the optical member according to the second embodiment but also the optical member according to first, third or fourth embodiment or the like can be applied.

The mounting substrate 92 includes the imaging element 91 and the optical member 94 joined together by a spacer 93 on one of the faces thereof and includes bumps 95 for connecting to an external apparatus on the other one of the faces thereof. The mounting substrate 92 is configured, for example, from a semiconductor substrate on which a semiconductor circuit and so forth are formed or the like.

The imaging element 91 has a light reception section formed on a face thereof opposite to the mounting face on the mounting substrate 92. The imaging apparatus is structured such that light from the outside is introduced to the light reception face of the imaging element 91 through the optical member 94 provided above the imaging element 91. Then, the light is detected by the light reception section provided on the light reception face.

The spacer 93 is formed surrounding the periphery of the imaging element 91 mounted on the mounting substrate 92. The spacer 93 is a joining element for joining the mounting substrate 92 and the optical member 94 to each other. Therefore, the imaging element 91 is covered with the mounting substrate 92, spacer or joining element 93 and optical member 94. Further, the upper portion of the imaging element 91 and the lower portion of the optical member 94 are joined together in a spaced relationship from each other by the spacer 93. Therefore, a space 96 sealed by the mounting substrate 92, spacer or joining element 93 and optical member 94 is provided.

Accordingly, a porous member can be provided on the spacer 93 similarly to the joining element of the optical member according to any of the first to fourth embodiments described above. For example, the spacer 93 may be made of ultraviolet curing resin and a porous member may be mounted in the spacer similarly as in the optical member according to the first, second or fourth embodiment. Further, for example, similarly as in the optical member according to the third embodiment, all of the entire spacers 93 may be formed from a porous member.

At this time, for the porous members to be provided on the spacer 93, a material having properties similar to those of the optical member according to the first embodiment described above can be used. By the configuration described above, the space 96 of the optical module is communicated with the outside through the porous members provided on the spacer 93. With the configuration, the space 96 of the optical module can carry out flow of gas such as air, water vapor or the like with the outside through the porous members, and besides invasion of foreign matters such as water, dust or the like into the space 96 of the optical member can be prevented.

In the optical module, the optical member 94 according to the second embodiment is produced, for example, by the method described above. Further, the imaging element 91 is mounted on one of the faces of the mounting substrate 92 formed from a semiconductor substrate on which a predetermined semiconductor circuit or the like is formed. Further, the bumps 95 of a conductive material for external connection are formed on the other one of the faces of the mounting substrate 92.

Then, on the mounting substrate 92 on which the imaging element 91 is mounted, ultraviolet curing resin which functions as a joining element is spread in a series of patterns surrounding the periphery of the imaging element 91.

Then, the optical member 94 is placed on the spread ultraviolet curing resin. Then, ultraviolet rays are irradiated upon the resin to harden the ultraviolet curing resin thereby to join the mounting substrate 92 and the optical member 94 to each other. By the step, the optical module wherein the spacer 93 functions as the joining element can be formed.

Further, when the spacer 93 is formed, the porous member can be provided in the joining element by the method described in the manufacturing methods for the optical member according to the first to fourth embodiments described above. Or, the joining element itself can be formed from a porous member.

Then, after the joining element is hardened, the mounting substrate 92 and the optical member 94 are cut at the spacer 93 thereof to carry out singulation. After the singulation, a heat treatment or the like is carried out for the optical member to thermally harden the joining element.

By the process described above, the optical module according to the present embodiment in which the optical member 94 is joined using the spacer 93 to the mounting substrate 92 on which the imaging element 91 is placed can be manufactured.

With the optical module according to the present embodiment, gas such as air, water vapor or the like can be communicated between the sealed space provided in the optical member or between the optical member and the mounting substrate and the outside through the porous member provided on the joining element.

Further, by using the porous member having water proofing and dust proofing properties, invasion of foreign matters into the optical member or the space between the optical member and the mounting substrate can be prevented.

While preferred embodiments of the disclosed technology have been described using specific terms, such description is for illustrative purposes only, and it is to be understood that changes and variations may be made without departing from the spirit or scope of the following claims.

The present disclosure contains subject matter related to that disclosed in Japanese Priority Patent Application JP 2010-202330 filed in the Japan Patent Office on Sep. 9, 2010, the entire content of which is hereby incorporated by reference.

What is claimed is:

1. An optical member, comprising:
a first substrate;
a second substrate opposed to said first substrate;
a joining element adapted to join said first and second substrates together in a spaced relationship from each other so as to provide a space between said first substrate and said second substrate; and
a porous member provided in said joining element;
at least one of said first and second substrates being formed from an optical transmission member;
the space being closed by said joining element and said porous member.

2. The optical member according to claim 1, wherein an air hole is provided in said joining element, and said porous member is provided so as to close up said air hole.

3. The optical member according to claim 1, wherein said porous member is joined to said first substrate and said second substrate.

4. The optical member according to claim 1, wherein said joining element includes a first joining element provided on said first substrate and having a concave portion provided thereon, and a second joining element provided on said second substrate and having a concave portion provided thereon, said concave portion of said second joining element being provided at a position overlapping with said concave portion of the first joining element, said porous member being provided at the position at which said concave portion of said first joining element and said concave portion of said second joining element overlap with each other.

5. The optical member according to claim 1, wherein said porous member is made of fluorocarbon resin.

6. The optical member according to claim 1, wherein said porous member is formed continuously in such a manner as to surround the space.

7. An optical module, comprising:
an imaging element;
an optical member having an optical transmission member provided on an optical path of light incoming to said imaging element;
a joining element adapted to join said imaging element and said optical member together in a spaced relationship from each other so as to provide a space between said imaging element and said optical member; and
a porous member provided in said joining element;
the space being closed by said joining element and said porous member.

8. The optical module according to claim 7, wherein said optical member includes first and second substrates individually formed from an optical transmission member and a joining element for joining said first and second substrates in a spaced relationship from each other.

9. The optical module according to claim 8, wherein said porous member is provided in said joining element which joins said first and second substrates together.
